(19) United States
(12) Patent Application Publication
(10) Pub. No.: US 2003/0142883 A1
(43) Pub. Date: Jul. 31, 2003

(54) Image correction data calculation method, image correction data calculation apparatus, and multi-projection system

(75) Inventor: Kensuke Ishii, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/339,177

(22) Filed: Jan. 9, 2003

(30) Foreign Application Priority Data
Jan. 17, 2002 (JP) 2002-009028

(51) Int. Cl. G06K 9/36; G06K 9/32

(52) U.S. Cl. 382/284; 382/294

(57) ABSTRACT

An image correction data calculation apparatus of the invention includes a calibration pattern display unit for creating and supplying a calibration pattern, an image display unit for displaying the calibration patterns supplied thereto, an image capturing unit for capturing the calibration patterns displayed on the image display unit, and an arithmetic operation unit for calculating image correction data based on pattern-captured images obtained by capturing the calibration patterns and based on pattern information including information such as the pattern-captured images obtained by capturing the calibration patterns, the coordinates of the calibration patterns, and the like.

This application claims benefit of Japanese Application No. 2002-9028 filed in Japan on Jan. 17, 2002, the contents of which are incorporated by this reference.

### BACKGROUND OF THE INVENTION

1. Field of the Invention

In a multi-projection system for projecting images on a screen using a plurality of projectors so that the images are jointed to each other, the present invention relates to an image correction data calculation method of and an image correction data calculation apparatus for automatically calculating the projecting positions of the respective projectors, and to a multi-projection system for correcting the images using the image correction data obtained by the method or the apparatus.

2. Description of Related Art

This type of a multi-projection system is generally composed of a screen for displaying images thereon, a plurality of projectors for projecting the respective images on prescribed regions on the screen, and an image controller for supplying an image signal as to an image shared by each projector.

Since the multi-projection system arranged as described above combines a plurality of images projected from the plurality of projectors and arranges them as a single image, the adjacent edges of respective images must be in alignment with each other, and if the edges are not in alignment with each other, the images cannot be arranged as the single image on the screen. Accordingly, in the multi-projection system, it is essential to align the projected positions of the images projected from the respective projectors onto the screen.

There is conventionally proposed an image correction data calculation method of calculating the projecting positions of a plurality of projectors to arrange a plurality of images projected from the respective projectors as a single image onto a screen.

As an example of the image correction data calculation method, Japanese Unexamined Patent Application Publication No. 9-326981, for example, discloses a technology for displaying pattern images on a screen from projectors, capturing the pattern images by a digital camera, calculating a parameter from the captured pattern images by a method such as a pattern matching method and the like, calculating image correction data for correcting the projecting positions of the projectors from the calculated parameter, and calculating the projecting positions of the projectors based on the image correction data.

The technology disclosed in Japanese Unexamined Patent Application Publication No. 9-326981, however, has the following problems: a) a method of processing the images captured by the camera is obscure because the publication does not disclose it in detail; b), the image correction data cannot be automatically calculated without the aid of a user because it is inevitable for the user to execute a manipulation; and c) when the projectors have a large amount of projective distortion, the manipulation executed by the user becomes complicated, and thus the user is required to execute a very troublesome job.

Accordingly, a technology capable of solving the above problems has been desired.

### SUMMARY OF THE INVENTION

An object of the present invention is to provide an image correction data calculation method, an image correction data calculation apparatus, and a multi-projection system capable of calculating image correction data without a complicated manipulation when images captured by a camera is processed.

To briefly describe, the present invention relates to an image correction data calculation method of calculating image correction data for aligning the positions of images projected from a plurality of projectors, the image correction data calculation method including a display step for supplying a calibration pattern to each of the projectors by a calibration pattern display means and displaying the calibration patterns from the respective projectors on a screen, an image capturing step for capturing the calibration patterns displayed at the display step by image capturing means as pattern-captured images, and an arithmetic operation step for calculating the image correction data based on the pattern-captured images obtained at the image capturing step and based on previously applied pattern information including the coordinate information of the calibration pattern.

Further, the present invention relates to an image correction data calculation apparatus for calculating image correction data for aligning the positions of images projected from a plurality of projectors, the image correction data calculation apparatus including a calibration pattern display means for creating and supplying a calibration pattern, an image display means for displaying the calibration patterns supplied from the calibration pattern display means, an image capturing means for capturing the calibration patterns displayed on the image display means, and an arithmetic operation means for calculating the image correction data based on pattern-captured images obtained by capturing the calibration patterns by the image capturing means and based on pattern information including the coordinate information of the calibration pattern.

Further, the present invention relates to a multi-projection system for correcting images projected from a plurality of projectors using image correction data for aligning the images, the multi-projection system includes an image transformation means for transforming the projecting positions of input image data based on the image correction data, and an image display means including the plurality of projectors and a screen for displaying the image data transformed by the image transformation means.

The above and other objects, features and advantages of the invention will become more clearly understood from the following description referring to the accompanying drawings.

### BRIEF DESCRIPTION OF THE DRAWINGS

FIG. 1 is a block diagram showing a schematic arrangement of a multi-projection system according to a first embodiment of the present invention;

FIG. 2 is a block diagram showing an example of an arrangement of the multi-projection system having an image correction data calculation apparatus according to the first embodiment;

FIG. 3 is a view showing an example of a marker calibration pattern used in the image correction data calculation apparatus according to the first embodiment;

FIG. 4 is a flowchart showing an example of an image correction data calculation method realized in the image correction data calculation apparatus according to the first embodiment;

FIG. 5 is a block diagram showing an arrangement of an image correction data calculation apparatus according to a second embodiment of the present invention;

FIG. 6 is a view showing an example of a screen calibration pattern previously set in the image correction data calculation apparatus according to the second embodiment;

FIG. 7 is a view showing an example of a marker calibration pattern previously set in the image correction data calculation apparatus according to the second embodiment;

FIGS. 8A and 8B are views explaining a relationship among a capturing area, search areas, and a calibration pattern in the image correction data calculation apparatus according to the second embodiment;

FIG. 9 is a block diagram showing a main portion of an arrangement of an image correction data calculation apparatus according to a third embodiment of the present invention;

FIG. 10 is a flowchart showing processing for calculating the coordinates of the corners of a screen and the coordinates of markers by a center-of-gravity detection method in the image correction data calculation method according to the third embodiment;

FIGS. 11A, 11B, 11C, 11D, 11E, 11F, and 11G are views showing how the coordinates of the corners of the screen and the coordinates of the markers are calculated by the center-of-gravity detection method in the processing of FIG. 10 in the image correction data calculation apparatus according to the third embodiment:

FIGS. 12A and 12B are views showing a screen calibration pattern used in a modification of the third embodiment;

FIGS. 13A, 13B and 13C are views showing a marker calibration pattern used in the modification of the third embodiment; and

FIG. 14 is a block diagram showing a multi-projection system using an image correction data calculation apparatus according to a fourth embodiment of the present invention.

### DESCRIPTION OF THE PREFERRED EMBODIMENTS

Embodiments of the present invention will be described below with reference to the drawings.

First Embodiment

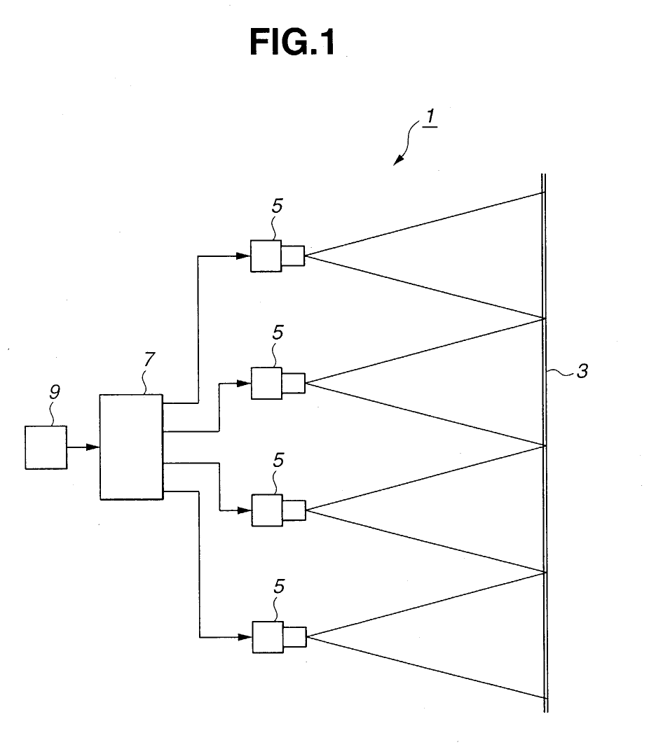

FIGS. 1 to 4 are views explaining a first embodiment of the present invention, wherein FIG. 1 is a block diagram showing a schematic arrangement of a multi-projection system.

As shown in FIG. 1, the multi-projection system 1 is composed of a screen 3 on which images are displayed, a plurality of projectors 5 (four sets are shown in the illustrated example) for projecting the respective images in prescribed regions on the screen 3, and a projector array controller 7 for supplying an image signal as to an image shared by each of the projectors 5.

The projector array controller 7 divides the image of a still image or a moving image supplied from an image source 9 into a plurality of images according to an arrangement of the plurality of the projectors 5 and supplies the divided images to the respective projectors 5.

The projector array controller 7 includes almost all the portions of an image correction data calculation apparatus 11 and an image transformation means for transforming the projecting positions of input image data using image correction data obtained by the image correction data calculation apparatus 11.

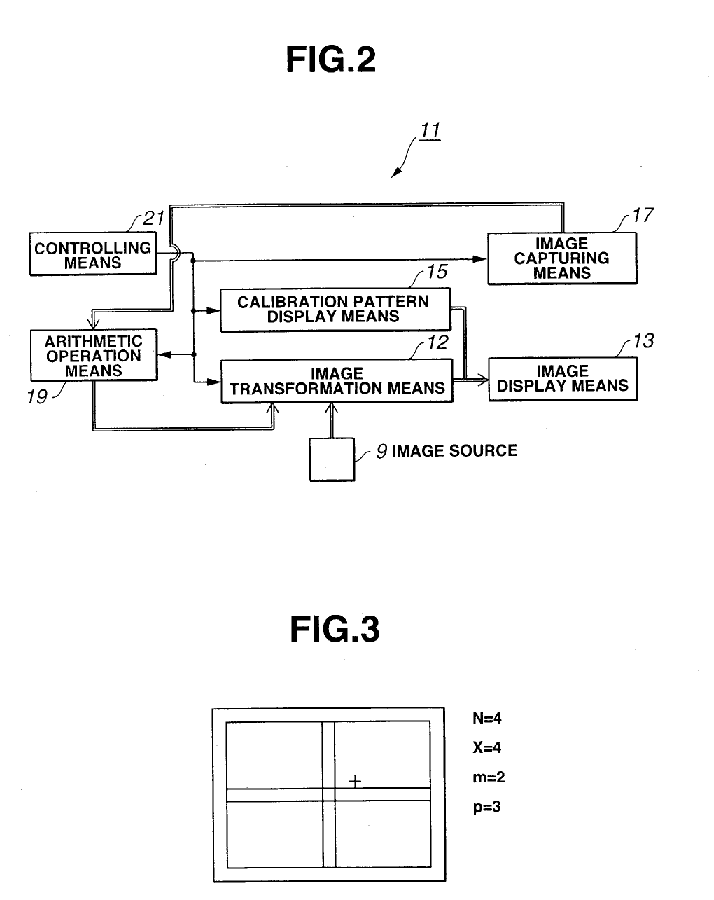

FIG. 2 is a block diagram showing an example of an arrangement of the multi-projection system 1 having the image correction data calculation apparatus.

The image correction data calculation apparatus 11 shown in FIG. 2 determines projecting positions from images obtained by capturing calibration patterns, which are shown in the respective projectors 5, by an image capturing means and calculates image correction data based on the thus determined projecting positions. The multi-projection system 1 realizes joint of the images based on the image correction data obtained by the image correction data calculation apparatus 11.

As shown in FIG. 2 in more detail, the image correction data calculation apparatus 11 is composed of an image display means 13, a calibration pattern display means 15, an image capturing means 17, an arithmetic operation means 19, and a controlling means 21. The image display means 13 includes the screen 3 and the plurality of projectors 5, the calibration pattern display means 15 causes the calibration patterns to be displayed on the image display means 13, the image capturing means 17 is composed of a digital camera and the like for capturing the calibration patterns displayed on the screen 3, the arithmetic operation means 19 calculates the image correction data based on pattern-captured images captured by the image capturing means 17 and based on pattern information including the coordinate information of the calibration pattern, and the controlling means 21 controls a plurality of these means.

Further, the multi-projection system 1 includes an image transformation means 12 and the above image display means 13. The image transformation means 12 captures the image correction data obtained by the image correction data calculation apparatus 11 and corrects the image supplied from the image source 9 under the control of the controlling means 21.

FIG. 3 is a view showing an example of a marker calibration pattern used in the image correction data calculation apparatus.

When the marker calibration pattern is displayed on the screen 3, it is displayed as a pattern having prescribed markers in a prescribed shape as shown in FIG. 3.

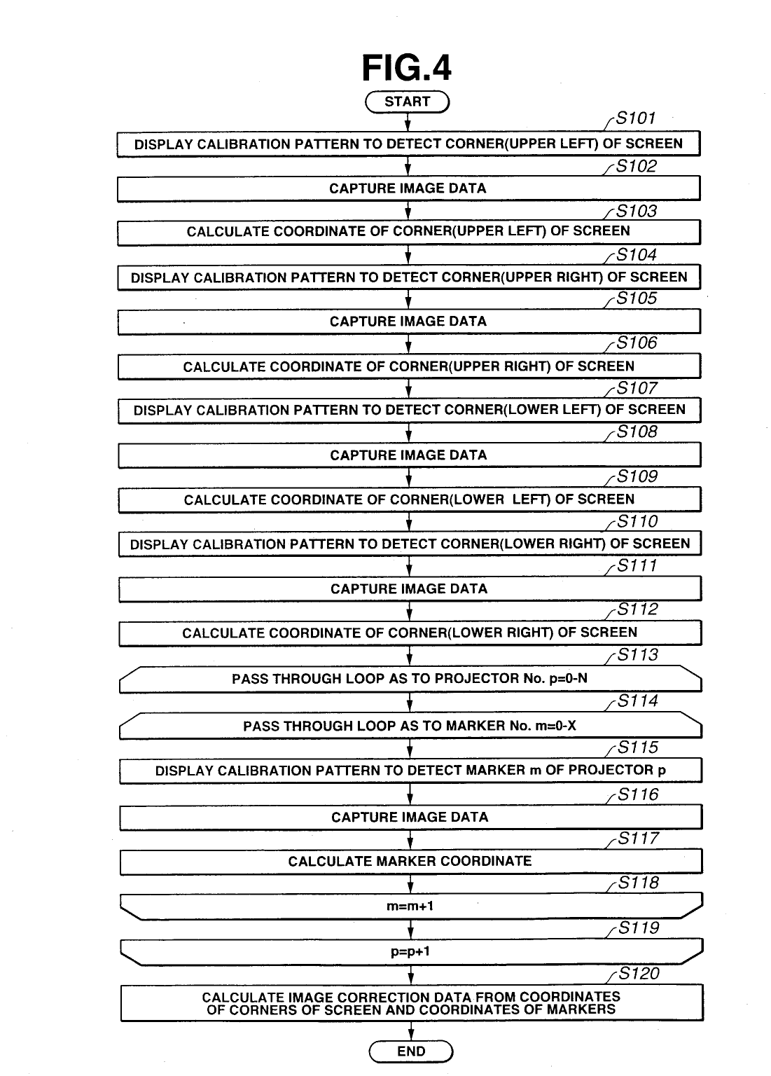

FIG. 4 is a flowchart showing an example of an image correction data calculation method realized in the image correction data calculation apparatus.

First, the calibration pattern display means 15 causes a calibration pattern for detecting an upper left corner of the screen 3 to be displayed on the image display means 13 under the control of the controlling means 21 (step S101).

Next, the image capturing means 17 captures the calibration pattern displayed on the image display means 13 and supplies a pattern-captured image to the arithmetic operation means 19 in response to an instruction from the controlling means 21 (step S102).

The arithmetic operation means 19 processes the pattern-captured image captured thereby and calculates the coordinate of the upper left corner of the screen 3 in the pattern-captured image in response to an instruction from the controlling means 21 (step S103).

Then, the calibration pattern display means 15 causes a calibration pattern for detecting an upper right corner of the screen 3 to be displayed on the image display means 13 under the control of the controlling means 21 (step S104).

The image capturing means 17 captures the calibration pattern displayed on the image display means 13 and supplies the pattern-captured image to the arithmetic operation means 19 in response to an instruction from the controlling means 21 (step S105).

Next, the arithmetic operation means 19 processes the pattern-captured image captured thereby and calculates the coordinate of the upper right corner of the screen 3 in the pattern-captured image in response to an instruction from the controlling means 21 (step S106).

Further, the calibration pattern display means 15 causes a calibration pattern for detecting a lower left corner of the screen 3 to be displayed on the image display means 13 under the control of the controlling means 21 (step S107).

The image capturing means 17 captures the calibration pattern displayed on the image display means 13 and supplies the pattern-captured image to the arithmetic operation means 19 in response to an instruction from the controlling means 21 (step S108).

Next, the arithmetic operation means 19 processes the pattern-captured image captured thereby and calculates the coordinate of the lower left corner of the screen 3 in the pattern-captured image in response to an instruction from the controlling means 21 (step S109).

Further, the calibration pattern display means 15 causes a calibration pattern for detecting a lower right corner of the screen 3 to be displayed on the image display means 13 under the control of the controlling means 21 (step S110).

The image capturing means 17 captures the calibration pattern displayed on the image display means 13 and supplies the pattern-captured image to the arithmetic operation means 19 in response to an instruction from the controlling means 21 (step S111).

Next, the arithmetic operation means 19 processes the pattern-captured image captured thereby and calculates the coordinate of the lower right corner of the screen 3 in pattern-captured image in response to an instruction from the controlling means 21 (step S112).

Next, the above loop is passed through once for each of the projectors 5 in the multi-projection system (step S113). Further the loop is passed through once every number of markers shown by each projector 5 (step S114). Note that while the loop is passed through as many times as p=0 to N at step S113 of FIG. 4, more specifically, the loop is passed through as many times as from an initial value of p=0 to p=N−1 and the process leaves the loop when it is confirmed that p=N is reached. Thus, the loop is passed through N times which are as many as the number of the projectors 5. Likewise, while the loop is passed through as many times as m=0 to X, the loop is passed through X times which are as many as the number of the markers.

Since the number of the projectors 5 changes depending upon an arrangement of the multi-projection system, the number of the projectors 5 is represented by N sets in this embodiment.

There is an optimum number of the markers depending on a degree of projective distortion of the projectors 5. A specific number of the markers is “4” when distortion can be completely ignored, and it is larger than “4” when images are projected onto an arch- and dome-shaped screens. It is needless to say that a larger number of the markers require a longer processing time. Thus, it is preferable to determine the optimum number of the markers depending on accuracy required when images are finally joined. In this embodiment, X pieces of the markers are employed.

In order to detect an m-th marker of a p-th projector 5, the calibration pattern display means 15 causes a calibration pattern to be displayed on the image display means 13 (step S115), the image capturing means 17 captures a displayed image of the calibration pattern (step S116), and the arithmetic operation means 19 calculates the coordinate of the marker using the pattern-captured image captured by the image capturing means 17 (step S117).

After the steps in the above loop are repeated until the coordinates of all the markers are calculated as to all the projectors 5 (steps S118 and S119), the arithmetic operation means 19 calculates the image correction data based on the coordinate information of the corners of the screen 3, the coordinate information of the markers, and the pattern information of the calibration patterns (step S120).

According to the first embodiment arranged as described above, the image correction data for correcting the projecting positions of the respective projectors 5 can be automatically calculated with pinpoint accuracy without a manipulation executed by a user.

Note that the arithmetic operation means 19 may calculate the coordinates of the corners of the screen 3 and the coordinates of the markers by investigating the coordinate having a maximum amount of luminance in the pattern-captured image, by executing pattern matching, or by detecting a center of gravity. Further, the coordinates of the corners of the screen 3 and the coordinates of the markers may be calculated using a different algorithm.

As an algorithm for calculating the image correction data for correcting the projecting positions of the respective projectors 5, a projection transformation algorithm may be used or an algorithm in consideration of rotation of projectors as that disclosed in Japanese Unexamined Patent Application Publication No. 9-326981 described above may be used. Even if any of the algorithms is employed in an image data calculation method, it can automatically calculate the projecting positions of the respective projectors without the need of the manipulation executed by the user.

Note that while the case in which the four projectors are used without being overlapped in the embodiment, the image calculation method can be applied similarly to a case in which they are overlapped. Further, there is not a limit in the number of the projectors employed in the multi-projection system as long as it employs at least two sets of the projectors.

Second Embodiment

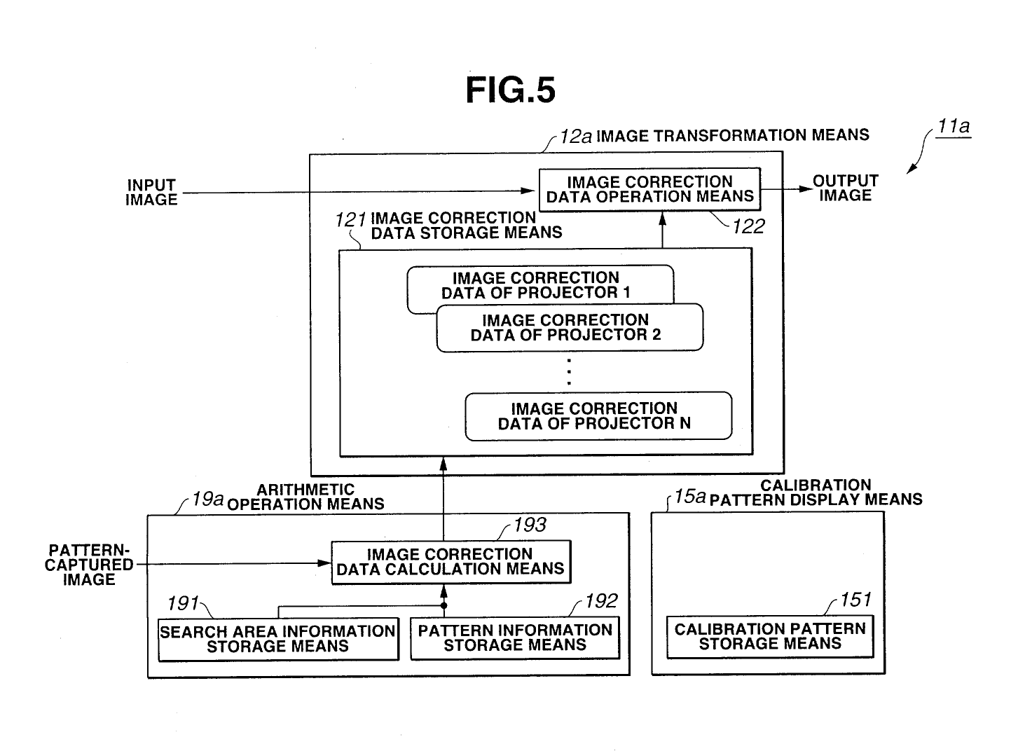

FIGS. 5 to 8B are views explaining a second embodiment of the present invention, wherein FIG. 5 is a block diagram showing an arrangement of an image correction data calculation apparatus. In the second embodiment, the same components as those of the first embodiment described above are not described in detail by appropriately referring to the reference numerals of them, and only a main difference therebetween will be described.

The image correction data calculation apparatus 11a according to the second embodiment is arranged such that it can process images more promptly than the image correction data calculation apparatus 11 of the first embodiment described above. That is, in the first embodiment, the corners of the screen and the markers are displayed one by one, and the image correction data is calculated by repeating the capturing operation and the calculation of the coordinates each time the corners and the markers are displayed, which requires a long time until the processing is finished. In contrast, in the second embodiment, the image correction data can be automatically calculated at a high speed by restricting search areas indicating the regions which are processed in a pattern-captured image from conditions such as accuracy with which a screen and projectors of a multi-projection system are mechanically assembled, a position where a digital camera is installed to capture calibration patterns and accuracy with which the digital camera is installed, the resolution of contents displayed by the multi-projection system, and the like.

To describe more specifically, the image correction data calculation apparatus 11a of the second embodiment is provided with a calibration pattern display means 15a which has a calibration pattern storage means 151 for storing at least one calibration pattern.

The image correction data calculation apparatus 11a is further provided with an arithmetic operation means 19a which includes a search area information storage means 191, a pattern information storage means 192, and an image correction data calculation means 193. The search area information storage means 191 stores at least one search area information, the pattern information storage means 192 stores at least one pattern information, and the image correction data calculation means 193 creates the image correction data based on pattern-captured images, the search area information, and the pattern information.

Further, the multi-projection system 1 is provided with an image transformation means 12a which includes an image correction data storage means 121 and an image correction data operation means 122. The image correction data storage means 121 stores the image correction data which is created by the image correction data calculation means 193 and correspond to the number of the projectors, and the image correction data operation means 122 creates output images by applying the image correction data to input images.

Further, the search area information stored in the search area information storage means 191, the pattern information stored in the pattern information storage means 192, and the calibration pattern stored in the calibration pattern storage means 151 can be determined from various design values in the multi-projection system 1. That is, the search area information can be set based on projecting positions of respective projectors 5 and accuracy with which the projectors 5 are assembled, a position where an image capturing means 17 is installed to capture the calibration pattern and accuracy with which the image capturing means 17 is installed, and the like. Further, the calibration pattern and the pattern information can be set based on the projecting positions of the respective projectors 5 and the accuracy with which the projectors 5 are assembled, resolution of the respective projectors 5, a magnitude of the projective distortion on a screen 3, and the like.

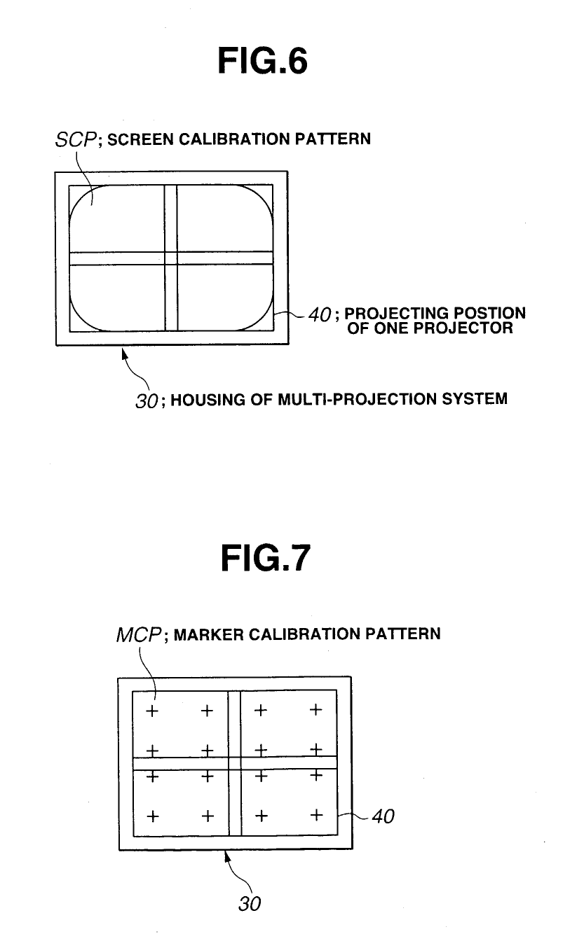

Next, calibration patterns, which can be previously set in the image correction data calculation apparatus 11a according to the second embodiment of the present invention, will be described with reference to FIGS. 6 and 7.

FIG. 6 is a view showing an example of a screen calibration pattern previously set in the image correction data calculation apparatus, and FIG. 7 is a view showing an example of a marker calibration pattern set in the image correction data calculation apparatus.

Data as to the calibration pattern CP stored in the calibration pattern storage means 151 of the calibration pattern display means 15a includes data for creating the screen calibration pattern SCP as shown in FIG. 6 on an image display means 13 and data for creating the marker calibration pattern MCP as shown in FIG. 7 on the image display means 13. Note that, in FIGS. 6 and 7, reference numeral 30 denotes a cabinet of the multi-projection system, and reference numeral 40 denotes a projecting position of one projector 5.

The calibration pattern display means 15a can read the screen calibration pattern SCP and the marker calibration pattern MCP from the calibration pattern storage means 151 and display them on the image display means 13.

The screen calibration pattern SCP is a pattern formed to accurately detect the four corners of the screen even if the projecting positions of the projectors 5 are shifted up, down, right, or left or turned somewhat by, for example, the assembly accuracy thereof.

Further, the marker calibration pattern MCP is a pattern for detecting the projecting positions of the respective projectors 5, and the number of the markers may be increased when a magnitude of the projective distortion is large.

Disposing the screen calibration pattern SCP and the marker calibration pattern MCP in the same pattern can reduce the number of times of capturing, thereby processing can be executed at a high speed.

Further, the marker calibration pattern MCP may be displayed for each of the projectors 5 or for a certain region of the respective projectors 5 to provide a margin with the installation accuracy of the projectors 5 and the image capturing means 17, while the number of times of the capturing increases.

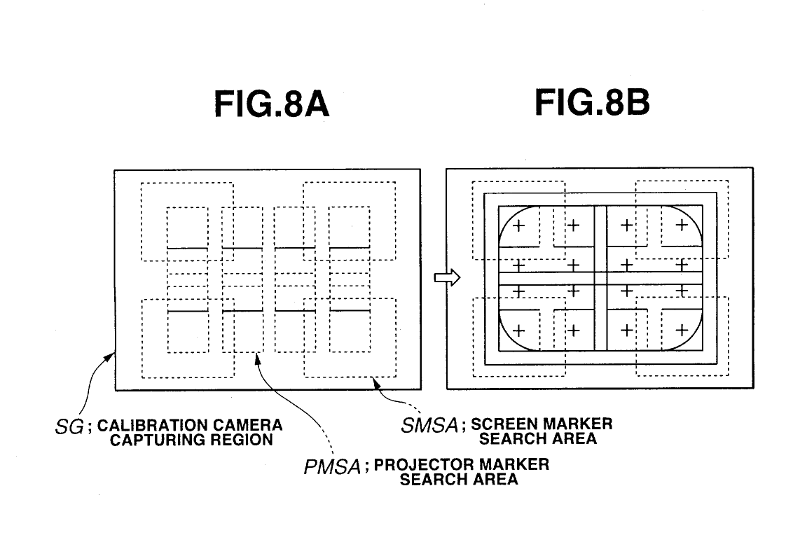

Next, the search area information will be described with reference to FIGS. 8A and 8B. FIGS. 8A and 8B are views explaining a relationship among a capturing region, search areas, and a calibration pattern in the image correction data calculation apparatus, wherein FIG. 8A is a view explaining a relationship between a capturing area to be captured by an image capturing means and a marker search area, and FIG. 8B is a view showing a relationship between an actually captured image and the marker search area.

As described above, the search area information 8A is stored in the search area information storage means 191. When the image capturing means 17 acting as a calibration camera is installed and the calibration pattern calibration pattern CP is captured thereby, the search area information SA designates a region in which a pattern to be noted is included in the capturing region SG of the camera. That is, as shown in FIG. 8A, the search area information SA includes projector marker search areas PMSA each having a relatively small area and disposed in a central portion of the capturing region SG and screen marker search areas SMSA each having a relatively large area and disposed at the four corners of the capturing region SG.

The sizes of the regions of the projector marker search areas PMSA and the screen marker search areas SMSA can be reduced when various means are installed with pinpoint accuracy, which can reduce an amount of the processing, thereby the processing can be executed at a high speed. On the contrary, when the sizes of the regions of the projector marker search areas PMSA and the screen marker search areas SMSA are increased, conditions of installation accuracy can be eased while a long processing time is required. Accordingly, it is preferable to determine the sizes of the regions of the projector marker search areas PMSA and the screen marker search areas SMSA in consideration of these relationships.

A relationship between these marker search areas PMSA and SMSA and actually captured calibration patterns SCP and MCP is as shown in FIG. 8B.

Since the image correction data calculation means 193 creates the image correction data using the calibration patterns SCP and MCP located in the marker search areas PMSA and SMSA as described above, an amount of the processing can be reduced and the processing can be executed at a high speed.

Note that the resolution of the respective projectors 5, the number of markers to be shown in each projector, the coordinates of the respective markers, and the like are exemplified as the pattern information stored in the pattern information storage means 192.

For example, the pattern information includes resolution of the respective projectors 5: 800×600, a number of the markers: 4, a coordinate of a first marker: (100, 100), a coordinate of a second marker: (700, 100), a coordinate of a third marker: (100, 500), a coordinate of a fourth marker: (700, 500), and the like.

The image correction data can be automatically calculated at a high speed by previously creating various types of information and data each provided with a margin from the design values of the multi-projection system as described above. It is needless to say that the information and the data each provided with a margin may be previously created without using the design values after at least one set of the multi-projection system having been assembled is checked.

Third Embodiment

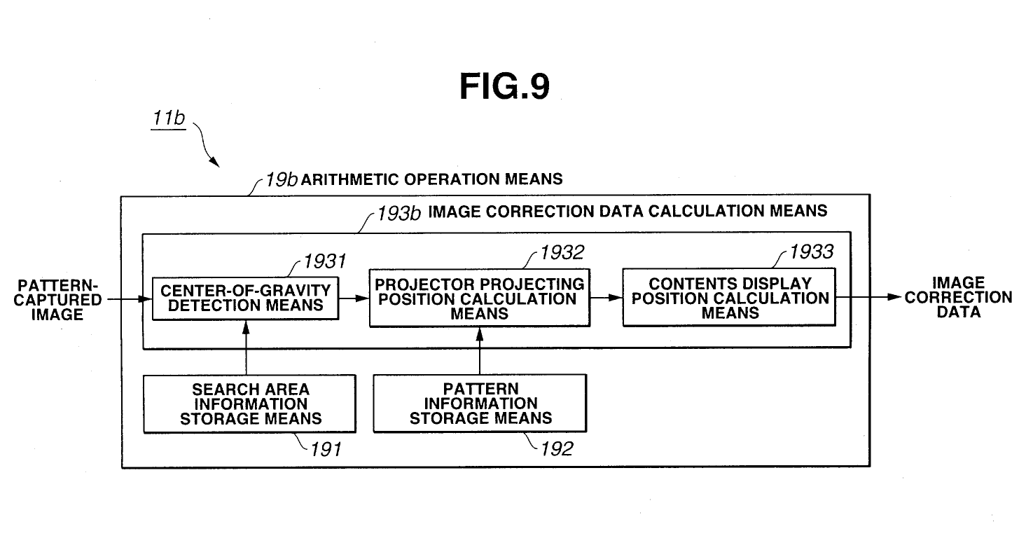

FIGS. 9 to 11G are views explaining a third embodiment of the present invention, wherein FIG. 9 is a block diagram showing a main portion of an arrangement of an image correction data calculation apparatus. In the third embodiment, the same components as those of the first and second embodiments described above are not described in detail by appropriately referring to the reference numerals of them, and only a main difference therebetween will be described.

In the image correction data calculation apparatus 11b according to the third embodiment, the coordinates of the corners of a screen and the coordinates of markers can be calculated at a high speed with pinpoint accuracy by using a center-of-gravity detection algorithm for calculating the coordinates of the corners of the screen and the coordinates of the markers and by devising a screen calibration pattern and a marker calibration pattern.

To describe more specifically, an arithmetic operation means 19b of the image correction data calculation apparatus 11b includes a search area information storage means 191, a pattern information storage means 192, and an image correction data calculation means 193b as shown in FIG. 9.

The image correction data calculation means 193b includes a center-of-gravity detection means 1931, a projector-projecting-position calculation means 1932, and a contents display position calculation means 1933. The center-of-gravity detection means 1931 calculates the coordinates of the corners of a screen and the coordinates of markers using a center-of-gravity detection method based on the pattern-captured images captured from an image capturing means 17 and based on the search area information stored in the search area information storage means 191. The projector-projecting-position calculation means 1932 calculates the projecting positions of respective projectors based on the coordinates of the screen and the coordinates of the markers calculated by the center-of-gravity detection means 1931 and based on the pattern information stored in the pattern information storage means 192. The contents display position calculation means 1933 executes a calculation for applying contents, which are desired to be finally displayed, onto a screen 3 of a multi-projection system 1 based on the information obtained from the projector-projecting-position calculation means 1932.

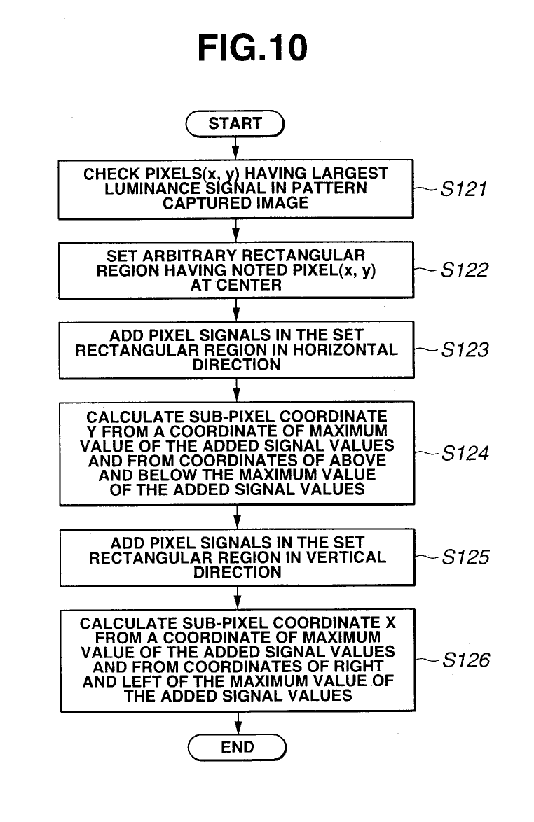

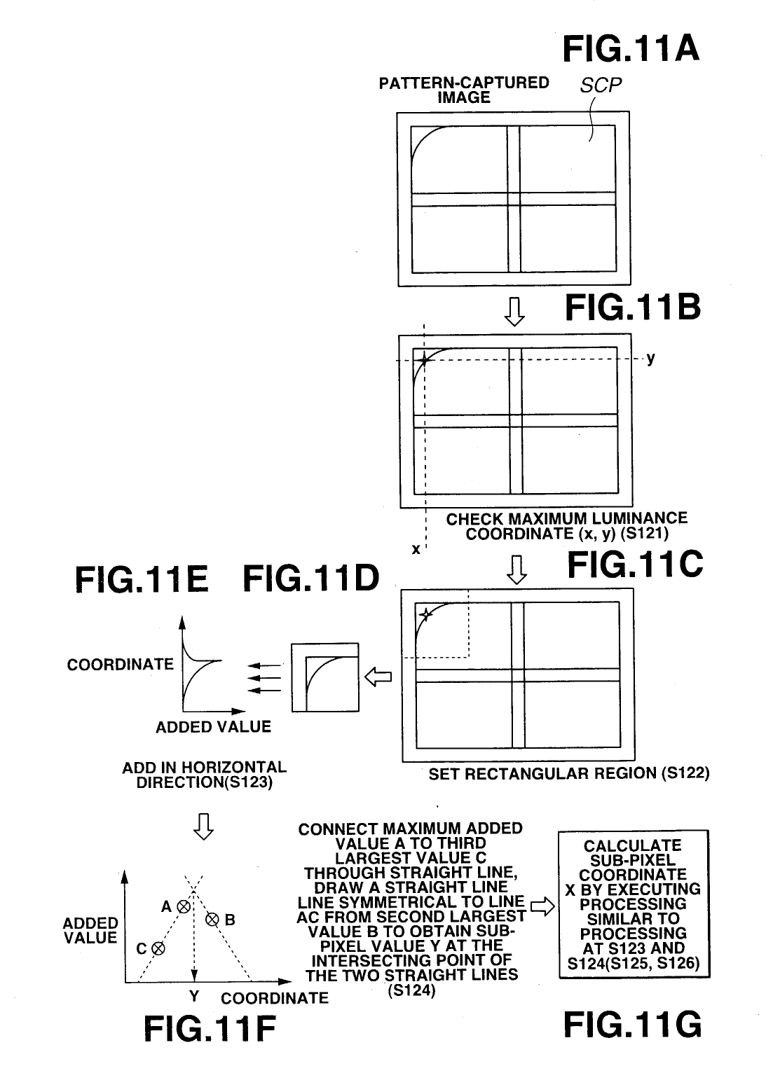

Next, operation of the image correction data calculation apparatus 11b described above will be described according to FIGS. 10, 11A, 11B, 11C, 11D, 11E, 11F, and 11G while referring to FIG. 9.

FIG. 10 is a flowchart showing processing for calculating the coordinates of the corners of the screen and the coordinates of the markers by the center-of-gravity detection method in the image correction data calculation apparatus. FIGS. 11A, 11B, 11C, 11D, 11E, 11F, and 11G are views showing how the coordinates of the corners of the screen and the coordinates of the markers are calculated by the center-of-gravity detection method by processing shown in FIG. 10 in the image correction data calculation apparatus.

First, a screen calibration pattern SCP at, for example, a corner (upper left corner) of a screen will be described as an example.

First, as shown in FIG. 11A, the image of the screen calibration pattern SCP at the corner (upper left) of the screen, which has been captured by the image capturing means 17, is captured by the center-of-gravity detection means 1931 of the arithmetic operation means 19b.

Next, as shown in FIG. 11B, the center-of-gravity detection means 1931 determines a pixel (x, y) having a largest luminance signal in an image in which the screen calibration pattern SCP at the corner of the screen is captured (step S121 of FIG. 10).

Then, as shown in FIG. 11C, the center-of-gravity detection means 1931 sets a rectangle which is formed in an arbitrary size and contains the pixel (x, y) therein as, for example, a center (step S122 of FIG. 10).

Subsequently, as shown in FIGS. 11D and 11E, the center-of-gravity detection means 1931 adds the data of pixels in the set rectangle in a horizontal direction (step S123 of FIG. 10).

Next, as shown in FIG. 11F, the center-of-gravity detection means 1931 determines a sub-pixel coordinate Y using the information of added values A, B, and C at the three points of a pixel, which has a maximum value of the added values, and pixels above and below the said pixel (step S124 of FIG. 10). That is, the center-of-gravity detection means 1931 connects the point having the maximum added value A to the point having the third largest added value C through a straight line (referred to as a straight line AC) and draws a straight line (referred to as a straight line B) which has an inclination whose absolute value is the same as the inclination of the straight line AC and whose sign is opposite to the sign of the straight line AC and which passes through the coordinate of the point having the second largest added value B, and determines the intersecting point of the straight line AC and the straight line B. Then, the coordinate of the intersecting point represents the value of the sub-pixel coordinate Y.

Likewise, the center-of-gravity detection means 1931 adds pixels in the set rectangle in a vertical direction (step S125 of FIG. 10) and then determines a sub-pixel coordinate X (step S126 of FIG. 10) as shown in FIG. 11G.

The coordinates of the four corners of the screen and the coordinate of the markers are determined by the calculation executed in the above sequence.

Next, the projector-projecting-position calculation means 1932 calculates the projecting positions of the respective projectors based on the coordinates of the screen and the coordinates of the markers calculated by the center-of-gravity detection means 1931 as described above and based on the pattern information stored in the pattern information storage means 192 and supplies the calculated data to the contents display position calculation means 1933.

The contents display position calculation means 1933 executes the calculation for applying the contents, which are desired to be finally displayed, onto the screen 3 of the multi-projection system 1 based on the information obtained from the projector-projecting-position calculation means 1932 and supplies a result of the calculation to an image transformation means 12.

According to the image correction data calculation apparatus 11b arranged as described above, since the sub-pixel coordinates X and Y are obtained by detecting the center-of-gravity by the center-of-gravity detection means 1931, the image correction data can be calculated at a speed higher than a case in which the sub-pixel coordinates X and Y are obtained by executing pattern matching and the like.

Modification of Third Embodiment

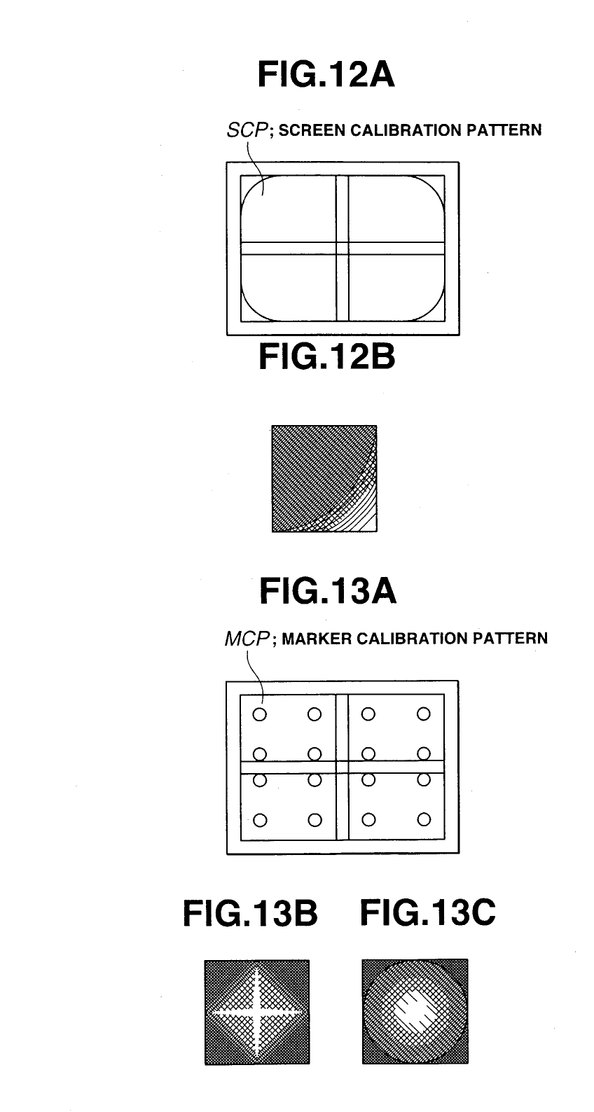

FIGS. 12A to FIG. 13C are views explaining a modification of the third embodiment of the present invention. FIGS. 12A and 12B are views showing a screen calibration pattern, wherein FIG. 12A shows the screen calibration pattern in its entirety, and FIG. 12B shows a part of the pattern in enlargement. FIGS. 13A, 13B, and 13C are views showing a marker calibration pattern, wherein FIG. 13A shows the marker calibration pattern in its entirety, and FIGS. 13B and 13C show a part of the pattern in enlargement, respectively.

In the modification of the third embodiment, the same components as those of the third embodiment described above are not described in detail by appropriately referring to the reference numerals of them, and only a main difference therebetween will be described.

As shown in FIG. 12B, a screen calibration pattern SCP captured by an image capturing means 17 has a gradation which changes so that brightness gradually increases toward corners (the pattern becomes lighter toward the corners). Likewise, a marker calibration pattern MCP captured by the image capturing means 17 has a gradation which changes so that brightness gradually increases toward a center (the pattern becomes lighter toward the center) as shown in FIGS. 13B and 13C.

When coordinates are calculated by the center-of-gravity detection means 1931 of the above arithmetic operation means 19b, calculation accuracy can be improved by preparing the screen calibration pattern SCP or the marker calibration pattern MCP as described above.

It is possible to calculate the image correction data at a high speed with pinpoint accuracy by using the calculation method as described above in the above arrangement.

Fourth Embodiment

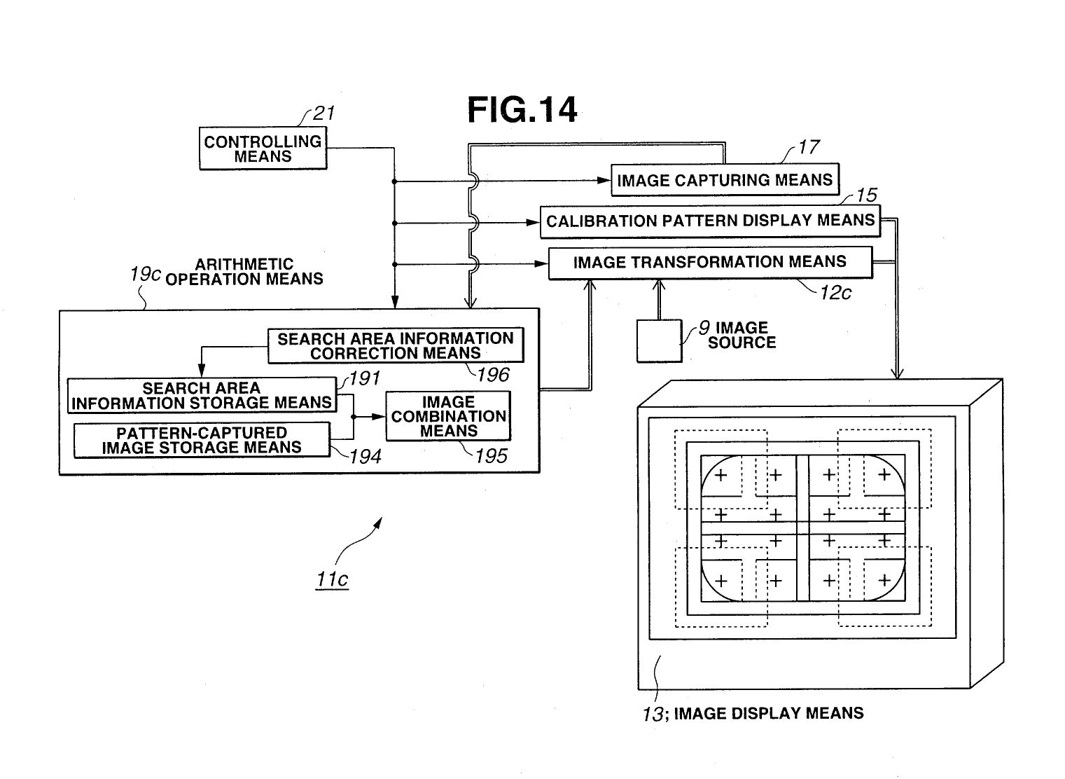

FIG. 14, explaining a fourth embodiment of the present invention, is a block diagram showing a multi-projection system using an image correction data calculation apparatus according to the present invention. In the fourth embodiment, the same components as those of the first to third embodiments described above are not described in detail by appropriately referring to the reference numerals of them, and only a main difference therebetween will be described.

In the fourth embodiment, it is possible to confirm whether or not calculated image correction data is correct after it has been calculated.

As shown in FIG. 14, the image correction data calculation apparatus 11c includes an image display means 13, a calibration pattern display means 15, an image capturing means 17, an arithmetic operation means 19c, and a controlling means 21. Further, a multi-projection system 1 includes an image source 9, an image transformation means 12c, an image display means 13, and a controlling means 21.

The arithmetic operation means 19c includes a pattern-captured-image storage means 194, a search area information storage means 191, an image combination means 195, and a search area information correction means 196. The pattern-captured-image storage means 194 stores a pattern-captured image captured by the image capturing means 17, the search area information storage means 191 stores search area information, the image combination means 195 creates an output image by combining the pattern-captured-image and the search area information and supplies the output image to the image transformation means, and the search area information correction means 196 corrects the search area information stored in the search area information storage means 191.

Next, operations of the image correction data calculation apparatus 11c and the multi-projection system 1 described above will be described.

First, calibration pattern information is supplied from the calibration pattern display means 15 to the image display means 13, and a calibration pattern CP is displayed on the image display means 13.

Next, the calibration pattern CP displayed on the image display means 13 is captured by the image capturing means 17. The pattern image of the calibration pattern CP captured by the image capturing means 17 is supplied to the arithmetic operation means 19c and stored in the pattern-captured image storage means 194.

The arithmetic operation means 19c calculates the image correction data based on the pattern image of the calibration pattern CP obtained thereby. The image correction data calculated here is supplied to the image transformation means 12c and stored in the image correction data storage means 121 (refer to FIG. 5).

Thereafter, the arithmetic operation means 19c combines the pattern-captured image stored in the pattern-captured image storage means 194 with the search area information stored in the search area information storage means 191 through the image combination means 195 and creates an image in which the search areas (a projection marker search area PMSA and a screen marker search area SMSA) are overlaid on the pattern captured image. Note that when a plurality of images are captured by capturing patterns, the combination process is executed as to all the pattern-captured-images.

The image combined as described above is supplied to the image transformation means 12c. The image transformation means 12c supplies the image received thereby to the image display means 13.

With the above operation, the image in which the search areas (the projection marker search area PMSA and the screen marker search area SMSA) are overlaid on the pattern-captured-image is displayed on a screen 3 of the image display means 13 as shown in FIG. 14.

A user can visually confirm whether or not the image correction data is successfully calculated by observing the displayed image. If a subject being noted (a corner of the screen or a marker) is located outside of the search areas in the visual confirmation of the image, the user manually changes setting using the search area information correction means 196. With this operation, the image correction data calculation apparatus 11c can calculate the image correction data again.

With the above arrangement, the user can not only easily confirm whether or not the image correction data is correctly calculated but also easily correct the image correction data even if it is not correctly calculated.

According to the image correction data calculation methods and the image correction data calculation apparatuses described above, the image correction data for correcting the projecting positions of the respective projectors in the multi-projection system can be automatically calculated with pinpoint accuracy without the need of a manipulation carried out by the user.

Then, according to the multi-projection system arranged as described above, it is possible to display a correct image.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims

What is claimed is:

1. An image correction data calculation method of calculating image correction data for aligning the positions of images projected from a plurality of projectors comprising:
a display step for supplying a calibration pattern to each of the projectors by calibration pattern display means and displaying the calibration patterns from the respective projectors on a screen;
an image capturing step for capturing the calibration patterns displayed at the display step by image capturing means as pattern-captured images; and
an arithmetic operation step for calculating the image correction data based on the pattern-captured images obtained at the image capturing step and based on previously applied pattern information including the coordinate information of the calibration pattern.

2. An image correction data calculation method according to claim 1, wherein when the image correction data is calculated, the arithmetic operation step determines search area information for defining regions in which the image correction data is calculated based on the design values of a system.

3. An image correction data calculation method according to claim 1, wherein when the image correction data is calculated, the arithmetic operation step determines the corners of the screen of a multi-projection system and the projecting positions of the respective projectors by a center-of-gravity detection method.

4. An image correction data calculation method according to claim 3, wherein the display step uses a calibration pattern having a gradation.

5. An image correction data calculation apparatus for calculating image correction data for aligning the positions of images projected from a plurality of projectors comprising:
calibration pattern display means for creating and supplying a calibration pattern;
image display means for displaying the calibration patterns supplied from the calibration pattern display means;
image capturing means for capturing the calibration patterns displayed on the image display means; and
arithmetic operation means for calculating the image correction data based on pattern-captured images obtained by capturing the calibration patterns by the image capturing means and based on pattern information including the coordinate information of the calibration pattern.

6. An image correction data calculation method according to claim 5, wherein the arithmetic operation means comprises:
search area information storage means for storing search area information for determining a calculation processing region in each of the pattern-captured images;
pattern information storage means for storing pattern information including the coordinate information of the calibration pattern; and
image correction data calculation mean for calculating the image correction data by applying the pattern information from the pattern information storage means and the search area information from the search area information storage means to the pattern-captured images captured from the image capturing means.

7. An image correction data calculation apparatus according to claim 6, wherein the image correction data calculation means comprises:
center-of-gravity detection means for subjecting the pattern-captured images captured from the image capturing means to center-of-gravity detection processing using the search area information from the search area information storage means and for calculating the coordinates of the corners of a screen and the coordinates of markers;
projector-projecting-position calculation mean for calculating the projecting positions of the respective projectors based on the coordinates of the corners of the screen, the coordinates of the markers obtained by the center-of-gravity detection means and the pattern information from the pattern information storage means; and
contents display position calculation means for executing a calculation for applying contents desired to be finally displayed on the screen based on the data from the projector-projecting-position calculation means.

8. An image correction data calculation apparatus according to claim 5, wherein the calibration pattern display means outputs a calibration pattern having a gradation.

9. An image correction data calculation apparatus according to claim 5, wherein the arithmetic operation means comprises:
search area information storage means for storing search area information for determining a calculation processing region in each of the pattern-captured images;
pattern-captured image storage means for storing the pattern-captured images;
image combination means for creating output images by combining the pattern-captured images stored in the pattern-captured image storage means with the search area information stored in the search area information storage means; and
search area information correction means for correcting the search area information.

10. A multi-projection system for correcting images projected from a plurality of projectors using image correction data for aligning the images comprising:
image transformation means for transforming the projecting positions of input image data based on the image correction data; and
image display means comprising the plurality of projectors and a screen for displaying the image data transformed by the image transformation means.
